(19) United States
(12) Patent Application Publication
(10) Pub. No.: US 2026/0083116 A1
(43) Pub. Date: Mar. 26, 2026

(54) POISON DEPOSITING APPARATUS FOR REACHING INTO GOPHER HOLES

(71) Applicant: Brian Jarvis, Bonsall, CA (US)

(72) Inventor: Brian Jarvis, Bonsall, CA (US)

(21) Appl. No.: 18/896,192

(22) Filed: Sep. 25, 2024

(51) Int. Cl. A01M 25/00

(52) U.S. Cl. CPC A01M 25/006

(57) ABSTRACT

A poison depositing apparatus for depositing poison in a gopher hole includes a sheath and a slider rod slidably mounted in the sheath. A flexible tube is attached to the slider rod. When the slider rod is placed in an extended position with respect to the sheath, the flexible tube is housed in the sheath. The slider rod may be pushed into the sheath from the extended position to push the flexible tube out the other end of the sheath. A grabbing mechanism is mounted to the end of a cable which extends through the flexible tube and the slider rod. The grabbing mechanism is actuated by an actuator mounted to the slider rod, which is operable to push the cable through the slider rod and the tube to release jaws of the grabbing mechanism from engagement with a rim of the tube to open the jaws and release poison pellets.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to material handling apparatuses and more particularly pertains to a new material handling apparatus for depositing poison in a gopher hole or similar tunnel.

### (2) Description of Related Art Including Information Disclosed Under 37 CFR 1.97 and 1.98

The prior art discloses various poison depositing devices which may be inserted into the ground in order to drop poison pellets or similar items into a hole or tunnel beneath the ground surface. However, the prior art fails to describe such an apparatus which uses a telescopic snake to urge a grabbing mechanism into a gopher hole and a release mechanism mounted distally from the grabbing mechanism to release the poison pellets into the gopher hole.

### BRIEF SUMMARY OF THE INVENTION

An embodiment of the disclosure meets the needs presented above by generally comprising a sheath which is elongated between a first end and a second end and defines a channel therein which is open at the first and second ends of the sheath. A slider rod is slidably mounted in the sheath and extends through the first end of the sheath. The slider rod is movable between an extended position and a retracted position with respect to the sheath. A tube is coupled to the slider rod and extends from the slider rod through the channel of the sheath. The tube comprises a flexible material such that the tube is may bend to conform generally to a shape of a tunnel. The tube is urged out of the channel of the sheath through the second end of the sheath when the slider rod is moved from the extended position toward the retracted position. The tube has a free end opposite the slider rod and has a rim at the free end which defines an opening that extends into the tube.

A cable is slidably mounted in the slider rod and the tube. The cable has an actuation end proximate to a distal end of the slider rod with respect to the sheath.

The cable also has a grabbing end opposite the actuation end. A grabbing mechanism is mounted to the grabbing end of the cable. The grabbing mechanism comprises a plurality of jaws which are movable to alternately open and close. An actuator is mounted to the distal end of the slider rod and is operable to alternately open and close the grabbing mechanism.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a poison depositing apparatus according to an embodiment of the disclosure.

FIG. 2 is a side view of an embodiment of the disclosure in which a slider rod is in an extended position.

FIG. 3 is a side view of an embodiment of the disclosure in which a slider rod is in a retracted position.

FIG. 4 is a side view of an embodiment of the disclosure in which a slider rod is in a retracted position and a grabbing mechanism is opened via operation of an actuator.

FIG. 5 is an in-use view of an embodiment of the disclosure.

FIG. 6 is a perspective view of an embodiment of the disclosure.

### DETAILED DESCRIPTION OF THE INVENTION

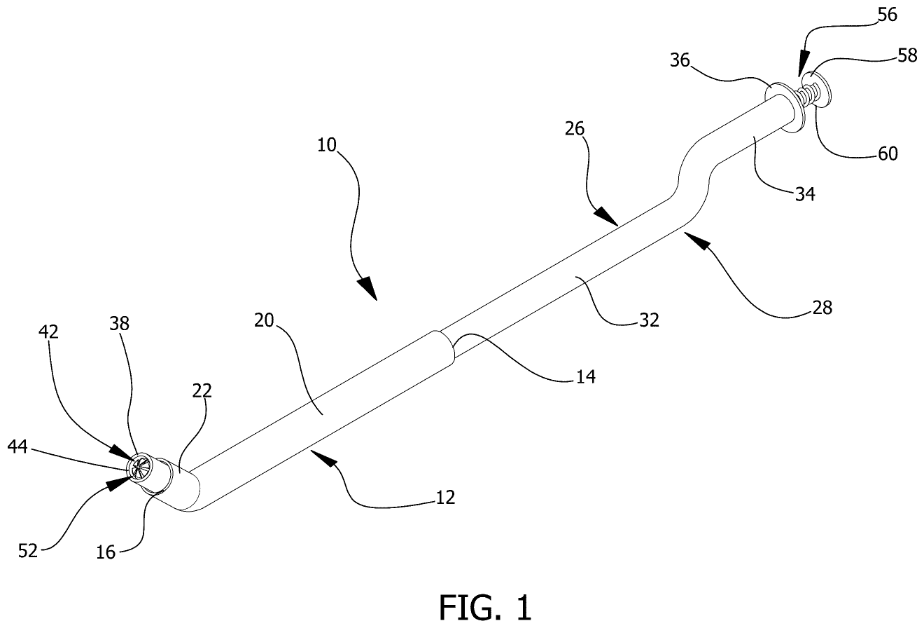

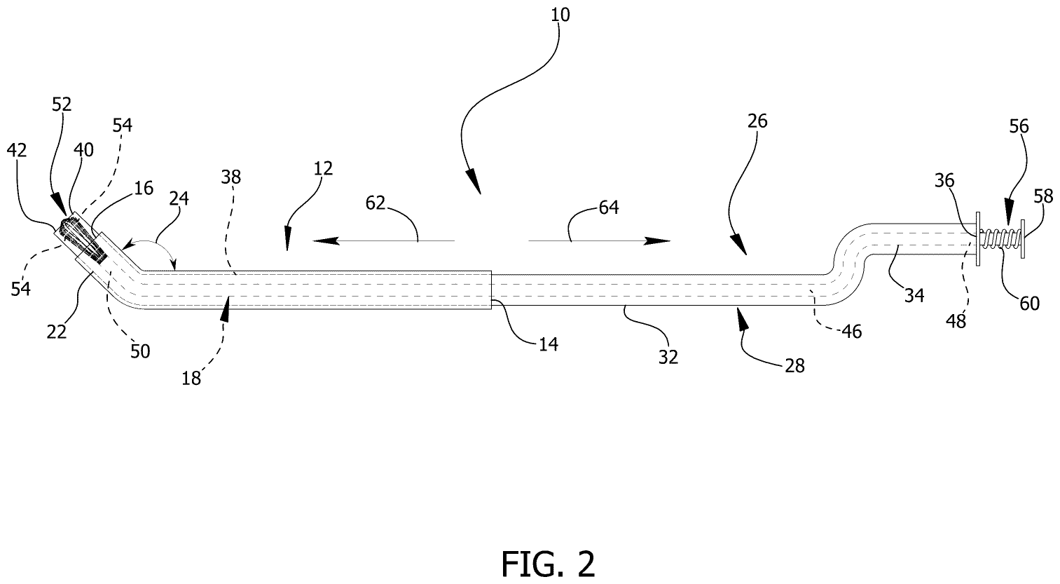

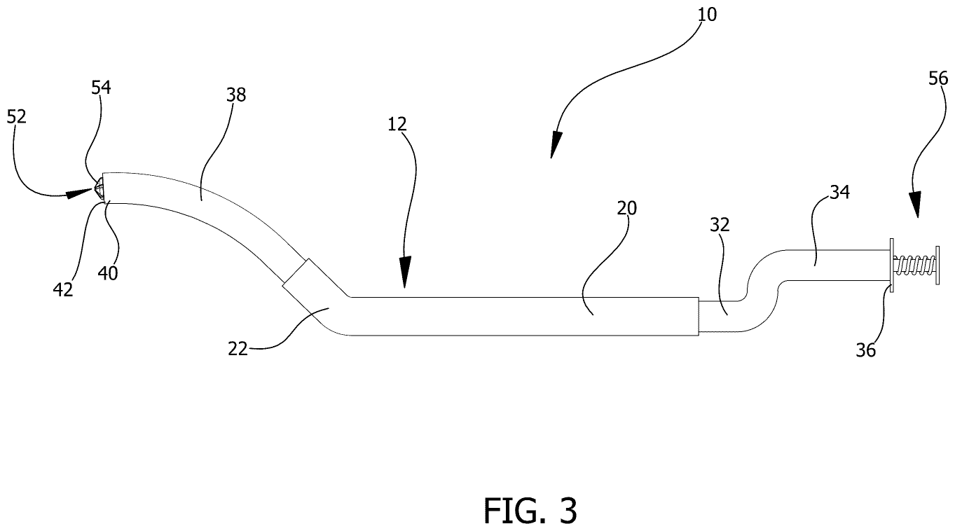

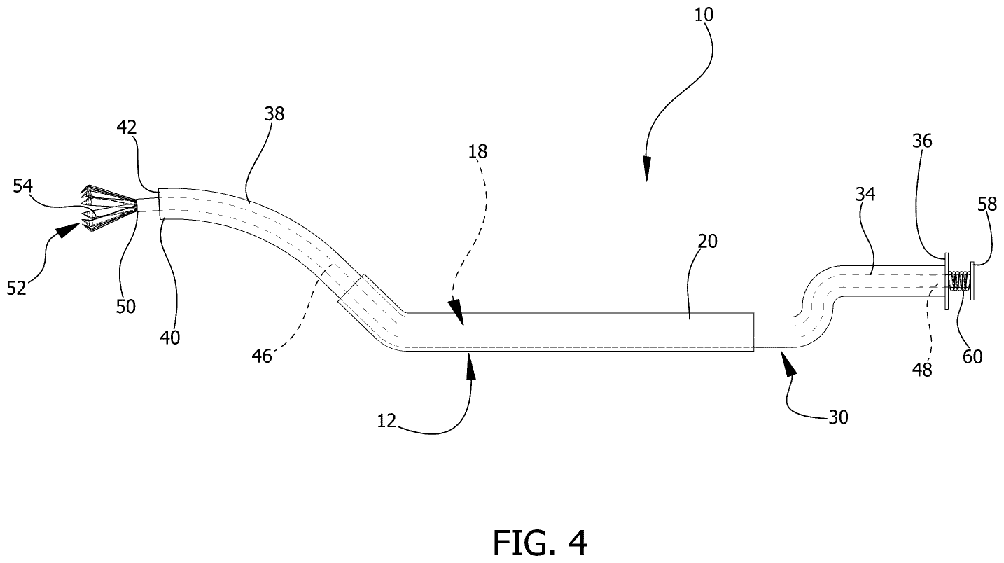

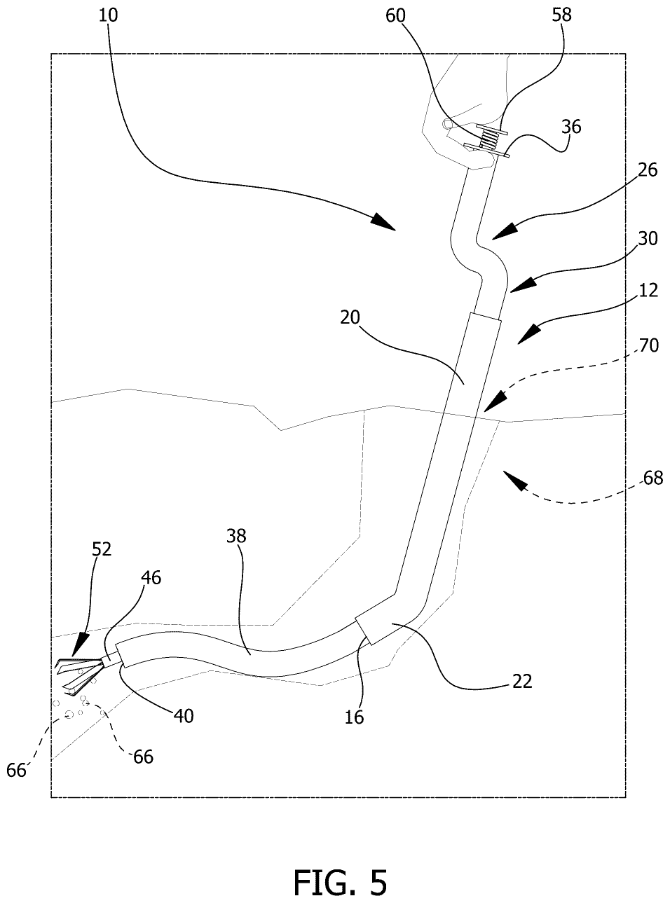

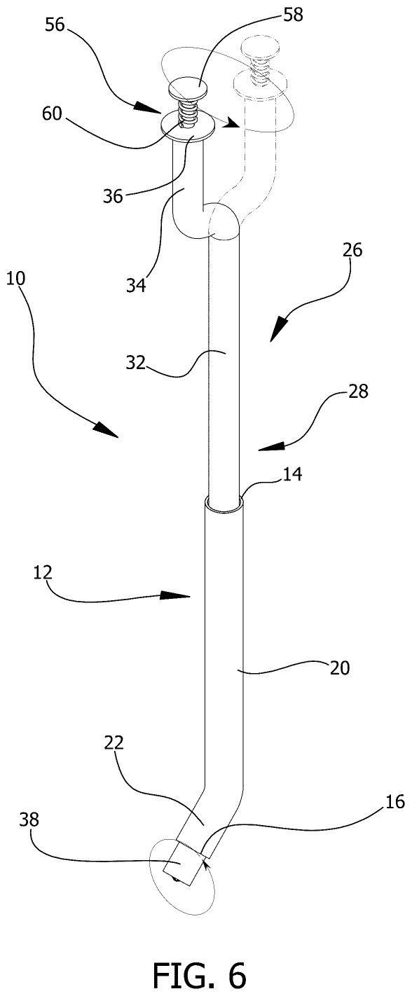

With reference now to the drawings, and in particular to FIGS. 1 through 6 thereof, a new material handling apparatus embodying the principles and concepts of an embodiment of the disclosure and generally designated by the reference numeral 10 will be described.

As best illustrated in FIGS. 1 through 6, the poison depositing apparatus 10 generally comprises a sheath 12 which is elongated between a first end 14 and a second end 16 and defines a channel 18 therein which is open at the first and second ends 14, 16 of the sheath 12. The sheath 12 comprises a main body 20 and an outlet portion 22. The main body 20 extends between the first end 14 of the sheath 12 and the outlet portion 22, and the outlet portion 22 extends between the main body 20 and the second end 16 of the sheath 12. The main body 20 is elongated, and the outlet portion 22 extends transversely with respect to a central longitudinal axis of the main body 20, forming an obtuse angle 24 with the main body 20.

A slider rod 26 is slidably mounted in the sheath 12 and extends through the first end 14 of the sheath 12. The slider rod 26 is movable between an extended position 28 and a retracted position 30 with respect to the sheath 12. The slider rod 26 comprises an insertion section 32 which is movable alternately into and out of the sheath 12 and a handle section 34 which is coupled to the insertion section 32 opposite the sheath 12.

Each of the insertion section 32 and the handle section 34 is elongated, and the handle section 34 is positioned parallel to and offset from the insertion section 32. In this manner, the handle section 34 may be grasped by a hand of a user to rotate the slider rod 26 in the sheath 12 by moving the handle section 34 around a central longitudinal axis of the insertion section 32. The handle section 34 may be grasped lightly enough that the handle section 34 rotates within the hand of the user. In other embodiments other levers, handles, or the like of various shapes may be employed to facilitate rotation of the slider rod 26 with respect to the sheath 12.

A tube 38 is coupled to the slider rod 26 and extends from the slider rod 26 through the channel 18 of the sheath 12. The tube 38 comprises a flexible material. For example, the tube 38 may comprise rubber, a plastic material, or the like. The flexible material may be a coiled metal wire similar to plumbing snakes or the like. The tube 38 is positioned such that it is urged out of the channel 18 of the sheath 12 through the second end 16 of the sheath 12 when the slider rod 26 is moved from the extended position 28 toward the retracted position 30. The tube 38 has a free end 40 opposite the slider rod 26 and has a rim 42 at the free end 40 which defines an opening 44 that extends into the tube 38.

A cable 46 is slidably mounted in the slider rod 26 and the tube 38. The cable 46 has an actuation end 48 proximate to a distal end 36 of the slider rod 26 with respect to the sheath 12. The cable 46 also has a grabbing end 50 opposite the actuation end 48. A grabbing mechanism 52 is mounted to the grabbing end 50 of the cable 46 which may be actuated to alternately grab and release items such as poison pellets 66 used in pest extermination procedures. The grabbing mechanism 52 comprises a plurality of jaws 54 which are movable to alternately open and close. The jaws 54 are shaped to define a volume within the plurality of jaws 54 when the jaws 54 are closed. The jaws 54 may each comprise, for example, leaves of sheet metal or similar sheet materials which extend outwardly from each other from the grabbing end 50 of the cable 46, then angle inwardly at end portions of the jaws 54. In this manner, lateral edges of the jaws 54 abut or overlap with each other when the jaws 54 are closed which facilitates enclosing the volume where poison pellets 66 or similar may be contained.

In some embodiments, the grabbing mechanism 52 may hold poison pellets 66 or other items by clamping onto the items. The jaws 54 are biased to open. In embodiments in which the jaws 54 comprise leaves of sheet metal or similar materials, the leaves may act as leaf springs which may be bent inwardly to close the jaws 54 and which are biased through a spring force to open. In other embodiments, other springs, elastic bands, magnets, or the like may be used to bias the jaws 54 open.

An actuator 56 is mounted to the distal end 36 of the slider rod 26 and is operable to move the cable 46 alternately in a first direction 62 through the slider rod 26 and the tube 38 and a second direction 64 opposite the first direction 62. The cable 46 urges the grabbing mechanism 52 away from the free end 40 of the tube 38 when moved in the first direction 62 and urges the grabbing mechanism 52 toward the free end 40 and against the rim 42 of the tube 38 when moved in the second direction 64. When the grabbing mechanism 52 is moved against the rim 42 of the tube 38, the rim 42 abuts exterior surfaces of the jaws 54, thereby urging the jaws 54 of the grabbing mechanism 52 to close.

The actuator 56 comprises a button 58 which is coupled to the cable 46 and is slidably mounted to the slider rod 26. The button 58 is pressed to push the cable 46 in the first direction 62, moving the grabbing mechanism 52 away from the free end 40 of the tube 38. As the grabbing mechanism 52 moves in this way, the jaws 54 are allowed to open via their bias and a release of the rim 42 of the tube 38 from the jaws 54. The button 58 is pulled to pull the cable 46 in the second direction 64, moving the grabbing mechanism 52 against the rim 42 of the tube 38, which urges the jaws 54 to close. At least part of the grabbing mechanism 52 may be stored in the tube 38 when the grabbing mechanism 52 is moved in this fashion. A compression spring 60 is coupled to and extends between the button 58 and the slider rod 26. The compression spring 60 biases the cable 46 in the second direction 64 by pushing the button 58 away from the slider rod 26. Other biasing means may be used such as other forms of springs, elastic bands, magnets, or the like.

In use, the button 58 of the actuator 56 may be pressed to open the jaws 54 of the grabbing mechanism 52, then released when the jaws 54 are placed around poison pellets 66 such that the jaws 54 close around the poison pellets 66 and contains them in the volume. The slider rod 26 may then be positioned in the extended position 28 such that the tube 38 is drawn into the sheath 12 at the second end 16 of the sheath 12. The entirety of the tube 38 need not be housed in the sheath 12, but it may be in some embodiments.

The sheath 12 may then be placed with the second end 16 near an entrance 70 to a tunnel 68 such as a gopher hole or similar where rodents or other pests may be found. The outlet portion 22 of the sheath 12 may be placed into the tunnel 68 and oriented to generally face in the path of the tunnel 68, which may be at a nonzero angle from the portion of the tunnel 68 nearest to the entrance 70. The slider rod 26 is inserted farther into the sheath 12, thereby pushing the tube 38 and the grabbing mechanism 52 further into the tunnel 68. The slider rod 26 may be rotated via the handle section 34 or otherwise to avoid the tube 38 bunching up inside the tunnel 68. By rotating the slider rod 26, the tube 38 is urged to rotate, and bends formed in the tube 38 will drag against interior surfaces of the tunnel 68, thereby adjusting the tube 38 to conform to the general path of the tunnel 68.

When a desirable depth into the tunnel 68 is reached by the grabbing mechanism 52, the button 58 of the actuator 56 is pressed again to open the jaws 54 and release the poison pellets 66. The tube 38 and the grabbing mechanism 52 may then be drawn out of the tunnel 68, such as by pulling the sheath 12 away from the entrance 70 of the tunnel 68 or by drawing the slider rod 26 toward the extended position 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A poison depositing apparatus comprising:
a sheath which is elongated between a first end and a second end, the sheath defining a channel therein, the channel being open at the first and second ends of the sheath;
a slider rod slidably mounted in the sheath and extending through the first end of the sheath, the slider rod being movable between an extended position and a retracted position with respect to the sheath;
a tube coupled to the slider rod, the tube extending from the slider rod through the channel of the sheath, the tube comprising a flexible material, the tube being urged out of the channel of the sheath through the second end of the sheath when the slider rod is moved from the extended position toward the retracted position, the tube having a free end opposite the slider rod, the tube having a rim at the free end defining an opening which extends into the tube;
a cable slidably mounted in the slider rod and the tube, the cable having an actuation end proximate to a distal end of the slider rod with respect to the sheath, the cable having a grabbing end opposite the actuation end;
a grabbing mechanism mounted to the grabbing end of the cable, the grabbing mechanism comprising a plurality of jaws which are movable to alternately open and close, wherein the plurality of jaws have abutting edges defining an enclosed space having a volume withing the plurality of jaws when the plurality of jaws is closed; and
an actuator mounted to the distal end of the slider rod, the actuator being operable to alternately open and close the grabbing mechanism.

2. The poison depositing apparatus of claim 1, wherein the sheath comprises a main body and an outlet portion, the main body extending between the first end of the sheath and the outlet portion, the outlet portion extending between the main body and the second end of the sheath, the main body being elongated, the outlet portion extending transversely with respect to a central longitudinal axis of the main body.

3. The poison depositing apparatus of claim 2, wherein the outlet portion forms an obtuse angle with the main body.

4. The poison depositing apparatus of claim 1, wherein the slider rod comprises an insertion section and a handle section which are coupled together, the insertion end being movable alternately into and out of the sheath, the handle section being coupled to the insertion section opposite the sheath, each of the insertion section and the handle section being elongated, the handle section being positioned parallel to and offset from the insertion section.

5. (canceled)

6. The poison depositing apparatus of claim 1, wherein the plurality of jaws is biased to open.

7. The poison depositing apparatus of claim 1, wherein the actuator is operable to move the cable alternately in a first direction through the slider rod and the tube and a second direction opposite the first direction, the cable urging the grabbing mechanism away from the free end of the tube when moved in the first direction, the cable urging the grabbing mechanism toward the free end and against the rim of the tube when moved in the second direction, thereby urging the plurality of jaws of the grabbing mechanism to close.

8. The poison depositing apparatus of claim 7, wherein the actuator is biased to move the cable in the second direction.

9. The poison depositing apparatus of claim 8, wherein the actuator comprises a button and a spring, the button being coupled to the cable and being movable with respect to the slider rod, the spring being coupled to the slider rod and the button, the spring being arranged to bias the button away from the slider rod.

10. A poison depositing apparatus comprising:
a sheath which is elongated between a first end and a second end, the sheath defining a channel therein, the channel being open at the first and second ends of the sheath, the sheath comprising a main body and an outlet portion, the main body extending between the first end of the sheath and the outlet portion, the outlet portion extending between the main body and the second end of the sheath, the main body being elongated, the outlet portion extending transversely with respect to a central longitudinal axis of the main body, the outlet portion forming an obtuse angle with the main body;
a slider rod slidably mounted in the sheath and extending through the first end of the sheath, the slider rod being movable between an extended position and a retracted position with respect to the sheath, the slider rod comprising an insertion section and a handle section which are coupled together, the insertion end being movable alternately into and out of the sheath, the handle section being coupled to the insertion section opposite the sheath, each of the insertion section and the handle section being elongated, the handle section being positioned parallel to and offset from the insertion section;
a tube coupled to the slider rod, the tube extending from the slider rod through the channel of the sheath, the tube comprising a flexible material, the tube being urged out of the channel of the sheath through the second end of the sheath when the slider rod is moved from the extended position toward the retracted position, the tube having a free end opposite the slider rod, the tube having a rim at the free end defining an opening which extends into the tube;
a cable slidably mounted in the slider rod and the tube, the cable having an actuation end proximate to a distal end of the slider rod with respect to the sheath, the cable having a grabbing end opposite the actuation end;
a grabbing mechanism mounted to the grabbing end of the cable, the grabbing mechanism comprising a plurality of jaws which are movable to alternately open and close, wherein the plurality of jaws have abutting edges defining an enclosed space having a volume withing the plurality of jaws when the plurality of jaws is closed, the plurality of jaws being biased to open; and
an actuator mounted to the distal end of the slider rod, the actuator being operable to move the cable alternately in a first direction through the slider rod and the tube and a second direction opposite the first direction, the cable urging the grabbing mechanism away from the free end of the tube when moved in the first direction, the cable urging the grabbing mechanism toward the free end and against the rim of the tube when moved in the second direction, thereby urging the plurality of jaws of the grabbing mechanism to close, the actuator being biased to move the cable in the second direction, the actuator comprising a button and a spring, the button being coupled to the cable and being movable with respect to the slider rod, the spring being coupled to the slider rod and the button, the spring being arranged to bias the button away from the slider rod.
